(19) United States
(12) Patent Application Publication
(10) Pub. No.: US 2018/0056171 A1
(43) Pub. Date: Mar. 1, 2018

(54) ANTI-STATIC PLAYING CARD

(71) Applicant: Tzu-Hsiang Tseng, Taichung City (TW)

(72) Inventor: Tzu-Hsiang Tseng, Taichung City (TW)

(21) Appl. No.: 15/253,872

(22) Filed: Sep. 1, 2016

(51) Int. Cl. A63F 1/00; B05D 1/02; B05D 1/28; B05D 5/00

(52) U.S. Cl. CPC A63F 1/00; B05D 5/00; B05D 1/28; B05D 1/02

(57) ABSTRACT

An anti-static playing card is a plastic playing card having a front surface and a back surface, wherein each of the surfaces has a first anti-static paint layer in which a surfactant and a coloring agent are added for displaying a suit and a number on the front surface and displaying a pattern on the back surface, and each of the surfaces has a transparent second anti-static paint layer that has a surfactant added therein and is coated over the first anti-static paint layer, so that the anti-static playing card is prevented from accumulation of static electricity.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to an anti-static playing card, and more particularly to a plastic playing card that is designed to prevent accumulation of static electricity that leads to mutual attraction or undesired displacement between cards that may interrupt a game played with the card and dampen the game-players' pleasure.

### Description of Related Arts

Playing cards represent one of the post popular entertainment appliances for playing games because there are many types of playing cards and many ways to play with the cards. Before any card games can start, playing cards belong to a deck have to be randomized through shuffling. For ensuring a fair game without cheats, an automatic card shuffer is often used so that none of participating players has the chance to control the shuffling process. However, playing cards used with such automatic card shuffer are preferably plastic playing cards for plastic is much more durable than paper. While plastic playing cards are relatively long-wearing, their material, namely plastic, tends to accumulate electric charges that are unlikely to move as the cards are stacked and rub against each other. These charges form static electricity that makes cards to attract each other. Such attraction between cards during a game, nevertheless, can cause wrong card-taking or false distribution of cards in terms of quantity and sequence and in turn may even bring about dispute about the win or loss of the game. Moreover, a deck of playing card stacked in a shuffer may have the upmost several cards shifting or displacing due to static electricity, this hinders a game from played fairly and appropriately. If a game is paused from time to time for manually correction, not only is the game risked unfairness, but also game-players' pleasure with the game is dampened. This is a problem with the known plastic playing cards needing a solution.

### SUMMARY OF THE PRESENT INVENTION

The present invention provides an anti-static playing card with the attempt to solve the foregoing problem, and the main technical scheme and the objective are: forming a first anti-static paint layer on the plastic playing card for showing a suit, a number and a pattern, and covering first anti-static paint layer of the plastic playing card with a second anti-static paint layer, so that the plastic playing card is made anti-static.

For achieving the aforementioned objective of the present invention, it is provided herein an anti-static playing card, which is a plastic playing card having a front surface and a back surface, wherein each of the surfaces has a first anti-static paint layer in which a surfactant and a coloring agent are added for displaying a suit and a number on the front surface and displaying a pattern on the back surface, and each of the surfaces has a transparent second anti-static paint layer that has a surfactant added therein and is coated over the first anti-static paint layer, so that the anti-static playing card is prevented from accumulation of static electricity.

In one embodiment of the present invention, the surfactant added in the first anti-static paint layer and the surfactant added in the second anti-static paint layer are both polyoxyethylene lauryl ether.

With the foregoing configuration, the plastic playing card is prevented from accumulation of static electricity. Thereby, the card is prevented form static electricity that leads to mutual attraction or undesired displacement between cards that may interrupt a game played with the card and dampen game-players' pleasure.

### BRIEF DESCRIPTION OF THE DRAWINGS

FIG. 1 is a front plane view of a plastic playing card of the present invention.

FIG. 2 is a back plane view of the plastic playing card of the present invention.

FIG. 3 is a cross-sectional view of the plastic playing card of the present invention.

### DETAILED DESCRIPTION OF THE PREFERRED EMBODIMENT

The invention as well as a preferred mode of use, further objectives and advantages thereof will be best understood by reference to the following detailed description of illustrative embodiments when read in conjunction with the accompanying drawings.

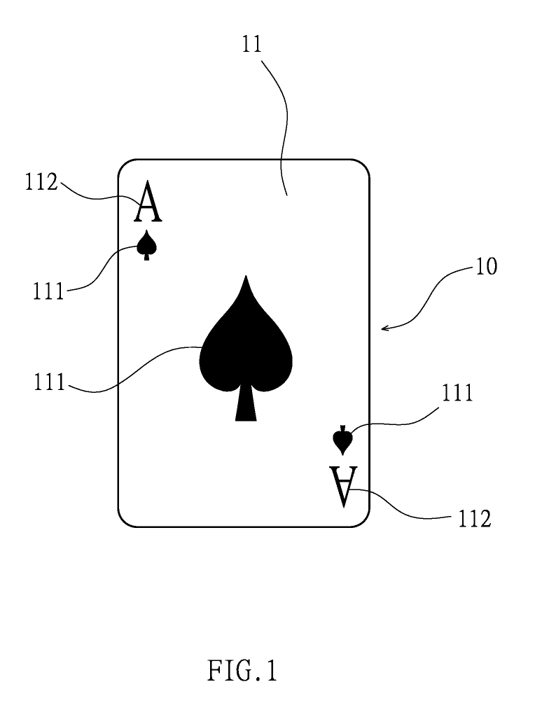

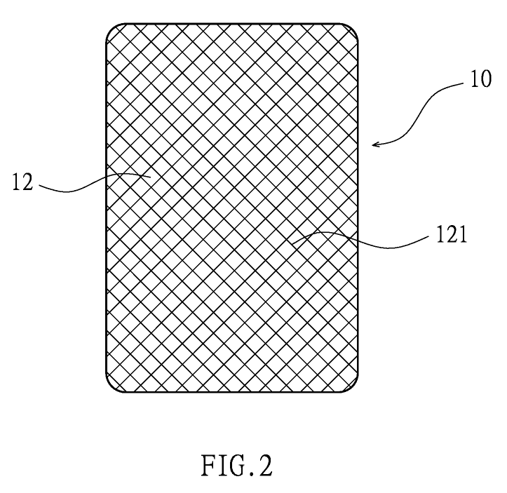

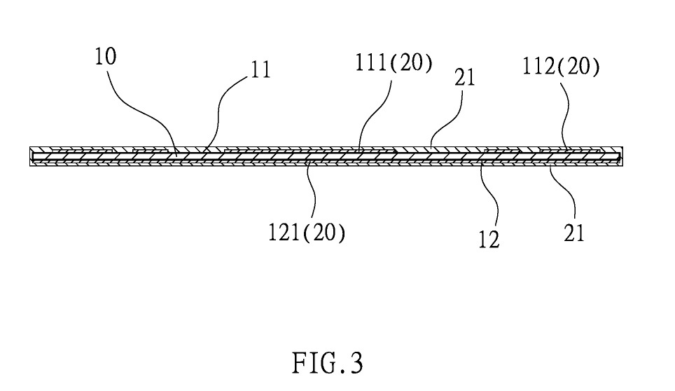

Referring to FIG. 1 through FIG. 3, a plastic playing card 10 has a front surface 11 and a back surface 12. Each of the surfaces of the plastic playing card 10 has a first anti-static paint layer 20 in which a surfactant and a coloring agent are added for showing a suit 111 and a number 112 on the front surface 11 and showing a pattern 121 on the back surface 12. A second anti-static paint layer 21 is coated on the outer surface of the combination of the plastic playing card 10 and the first anti-static paint layer 20. It is transparent and also added with a surfactant. With the foregoing configuration, the plastic playing card 10 is prevented from accumulation of static electricity.

The composition, effects and details of the foregoing embodiment will be discussed below. As shown in FIG. 1 through FIG. 3, the disclosed plastic playing card 10 has its front surface 11 displaying the suit 111 and the number 112 distinctive in a deck of said playing cards 10. The suit 111 and the number 112 may be printed using screen printing, and the first anti-static is added with a coloring agent (such as one for black, red, yellow or other colors) and a surfactant. The surfactant acts as a paint additive for reducing surface tension of the paint so as to improve clarity of the printing. In addition, the surfactant may be a non-ionic surfactant made of polyoxyethylene lauryl ether. When it is attached to the surface of the plastic material, outward-facing hydrophilic groups absorb trace moisture in the ambient environment, so that the surface of the plastic material has high moisture affinity and becomes electrically conductive, thereby allowing static electricity to escape along the surface of the object and leak timely. Then a printing plate having the same suit 111 and number 112 is reserved on the halftone, so that when printing is made on the front surface 11 of the plastic playing card 10, the first anti-static paint layer 20 containing the coloring agent permeates through the halftone and gets deposited on the front surface 11, thereby making the suit 111 and the number 112 with sharp contours. The anti-static paint may be cured by exposing it to ultraviolet. Then the same screen printing process is repeated for the back surface 12 to make the pattern 121, thereby completing printing of the front and back surfaces 11, 12 of the plastic playing card 10 and forming the first anti-static paint layer 20. The second anti-static paint layer 21 is made using a second anti-static paint that is transparent. For ensuring anti-static effects of the plastic playing card 10, the second anti-static paint is sprayed, applied or rolling-painted all over the front and back surfaces 11, 12 of the plastic playing card 10. In this case, the suit 111, the number 112, the pattern 121 and any other area that is not covered by the first anti-static paint can be covered by the second anti-static paint. Thereby the second anti-static paint layer 21 is formed to provide overall anti-static effects and contribute to improved endurance of the first anti-static paint layer 20.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An anti-static playing card, which is a plastic playing card having a front surface and a back surface, wherein each of the surfaces has a first anti-static paint layer in which a surfactant and a coloring agent are added for displaying a suit and a number on the front surface and displaying a pattern on the back surface, and each of the surfaces has a transparent second anti-static paint layer that has a surfactant added therein and is coated over the first anti-static paint layer, so that the anti-static playing card is prevented from accumulation of static electricity.

2. The anti-static playing card of claim 1, wherein the surfactant added in the first in anti-static paint layer and the surfactant added in the second anti-static paint layer are both polyoxyethylene lauryl ether.
